(19) United States
(12) Patent Application Publication
(10) Pub. No.: US 2015/0030528 A1
(43) Pub. Date: Jan. 29, 2015

(54) METHOD OF MAKING CHLORINE DIOXIDE

(71) Applicant: Ni Xu, Beijing (CN)

(72) Inventor: Ni Xu, Beijing (CN)

(21) Appl. No.: 14/111,972

(22) PCT Filed: Apr. 12, 2011
(86) PCT No.: PCT/CN11/00640

§ 371 Date: Oct. 9, 2014

(51) Int. Cl. C01B 11/02

(52) U.S. Cl. CPC C01B 11/024
USPC 423/477; 422/129

(57) ABSTRACT

A novel method of making chlorine dioxide is provided. The method includes the steps of combining a hypochlorite salt and trichloroisocyanuric acid reactants in solid state in an aqueous reaction medium; and mixing the reaction medium with a gaseous carrier under conditions suitable to generate chlorine dioxide. A novel apparatus for use in generating chlorine dioxide is also provided.

### FIELD OF THE INVENTION

The present application relates to a novel method and apparatus for making chlorine dioxide.

### BACKGROUND OF THE INVENTION

Chlorine dioxide is a powerful biocide, disinfectant and oxidizer. Chlorine dioxide can be generated in a gas or liquid form and smells like chlorine bleach. Chlorine dioxide, ClO₂, is advantageous over chlorine, because it functions via an oxidative reaction rather than a chlorinating reaction, the mode of action of chlorine gas. This virtually eliminates the formation of chlorinated organic compounds that are believed to be carcinogenic. In addition, chlorine dioxide can readily be generated on site.

Methods of generating chlorine dioxide are described in the prior art, as well as systems suitable for generating chlorine dioxide. For example, U.S. Pat. No. 7,452,511 describes a method and reactor for making chlorine dioxide in which reactants are fed into a reaction chamber in which chlorine dioxide gas is generated and released into a liquid stream for use.

U.S. Pat. No. 7,150,854 provides a device for generating aqueous chlorine dioxide solutions in which a chlorite and an acid reagent are disposed upon, and adhered to, the surface(s) of a substrate in a manner such that upon exposure to liquid water, the chlorite boundary layer comes into contact with the acid reagent boundary layer to produce an aqueous chlorine dioxide solution.

U.S. Pat. No. 7,488,457 describes a system for generating aqueous chlorine dioxide which includes an electrochemical acidification cell with an anode compartment, a cathode compartment and a central compartment containing a cation exchange material. An alkali metal chlorite solution is fed into the central compartment acidification cell and is then combined with a solid phase chlorine containing material to generate chlorine dioxide.

Given the importance of chlorine dioxide, it is desirable to develop alternate methods of generating chlorine dioxide.

### SUMMARY OF THE INVENTION

The present invention relates to a novel method of making chlorine dioxide using solid state reactants.

Thus, in one aspect of the invention, a method of producing chlorine dioxide is provided comprising:

1) combining hypochlorite salt and trichloroisocyanuric acid reactants in solid state in an aqueous reaction medium; and

2) mixing the reactants with a gaseous carrier under conditions suitable to generate gaseous chlorine dioxide,

In another aspect of the invention, an apparatus is provided comprising an inlet adapted to receive a compressed gaseous carrier, said inlet being in communication with a conduit that extends into a reaction reservoir, wherein the conduit has an opening that allows the gaseous carrier to be fed into a solution within the reservoir, and at least one outlet adapted to release gas from the reaction reservoir, wherein the inlet is partitioned from the outlet to prevent admixture of the incoming gaseous carrier with the gas being released from the reservoir via the outlet.

These and other aspects of the invention are described by reference to the following detailed description and drawings.

### BRIEF DESCRIPTION OF THE DRAWINGS

FIG. 1 is a block diagram illustrating an embodiment of the invention; and

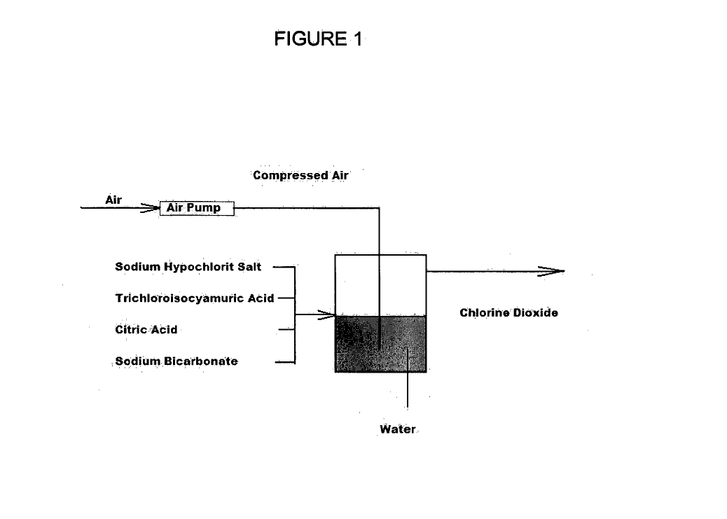

FIG. 2 is a cross-section of an apparatus for use in generating chlorine dioxide.

### DETAILED DESCRIPTION OF THE INVENTION

A method of producing chlorine dioxide is provided comprising combining a hypochlorite salt and trichloroisocyanuric acid reactants, both in solid state, in an aqueous reaction medium to form a solution and mixing the solution with a gaseous carrier under conditions suitable to generate gaseous chlorine dioxide.

Examples of suitable hypochlorite salts for use in the present method include, but are not limited to, alkali metal salts such as sodium hypochlorite, lithium hypochlorite, potassium hypochlorite, cesium hypochlorite, rubidium hypochlorite and francium hypochlorite. A preferred hypochlorite salt for use in the present method is sodium hypochlorite. The hypochlorite salt may be used in the solid state, in an amount ranging from about 40-60% by weight of the reactants.

Trichloroisocyanuric acid is a reactant for use in the present method. It may also be used in the solid state, in an amount ranging from about 20-30% by weight of the reactants.

The method of making chlorine dioxide comprises the step of adding appropriate amounts of the reactants, e.g. a hypochlorite salt and trichloroisocyanuric acid, each in the solid state, to an aqueous reaction medium, such as water, to form a solution. The reactant solution is mixed with a gaseous carrier, such as compressed air, at room temperature for a suitable period of time, e.g. about 3-10 minutes, preferably about 5 minutes, to generate chlorine dioxide gas. Using this method, chlorine dioxide gas is generated at an average conversion rate of about 60%, preferably at least about 70-80%, and more preferably at least about 85%, e.g. 90% or greater, e.g. about 95%.

As one of skill in the art will appreciate, other components may be used in the present method to optimize the production of chlorine dioxide. In this regard, an organic acid may optionally be added to the reaction medium. An organic acid is an organic compound with acidic properties. Carboxylic acids, such as citric acid, lactic acid, formic acid, acetic acid and oxalic acid, are suitable organic acids for use in the present method. Organic sulfonic acids may also be used. A preferred organic acid for use in the present method is citric acid. The organic acid may be utilized in solid state, in an amount ranging from about 20-30% by weight of the reactants.

A bicarbonate may also be optionally added to the reaction medium for use in the present method of making chlorine dioxide. Examples of suitable bicarbonates include, but are not limited to, alkali metal salts such as sodium bicarbonate and potassium bicarbonate. The bicarbonate may also be used in the solid state, in an amount ranging from about 1-3% by weight of the reactants.

In another aspect of the invention, an apparatus for use in preparing chlorine dioxide is provided. The apparatus comprises an inlet adapted to receive a compressed gaseous carrier. The inlet is in communication with a conduit that extends into a reaction reservoir in which the solid state reactants, e.g. the hypochlorite salt, trichloroisocyanuric acid and any other reactants, are admixed with an aqueous solvent to form a solution. The apparatus additionally includes at least one outlet to release gas from the reservoir. The outlet is partitioned from the inlet to prevent admixture of the incoming gaseous carrier with the gases being released from the reservoir via the outlet.

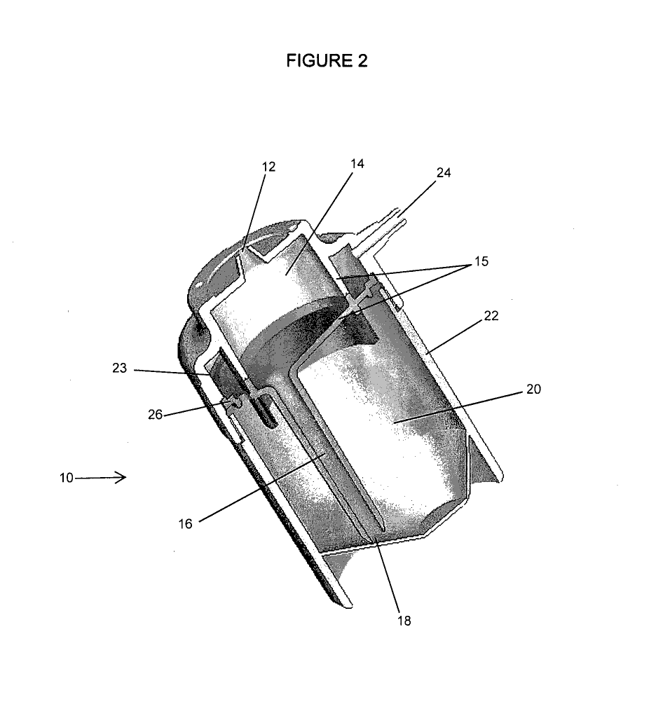

An apparatus 10 according to one embodiment of the invention is shown in FIG. 2. The apparatus includes an inverted conically-shaped inlet 12 at the centre of the top of the apparatus 10. The inlet 12 feeds into a chamber 14 from which one or more narrow conduits 16 extend. The conduit 16 extends into a reaction reservoir 20 such that the reservoir 20 envelops the conduit 16. The conduit 16 is adapted to feed a gas into the reservoir through opening 18 located at the base of the conduit 16. The walls 15 of chamber 14 partition the inlet 12 from one or more outlets 24 formed in an outside wall 22 at the top of the reservoir 20 of the apparatus 10. An internal ledge 26 extends around the circumference of the apparatus at the top of reservoir 20 and between the outside wall 22 and the walls 15 of chamber 14 to form a gas holding chamber 23. Holes formed within the ledge allow gases to exit from the reservoir 20 into chamber 23 for release from the apparatus through outlet 24. The ledge 26 is useful to prevent release of the solution from the reaction reservoir 20 through outlet 24.

The apparatus may additionally comprise means to generate the gaseous carrier, such as an air compressor, pump or blower that may be connected to the inlet 12 in order to deliver the gaseous carrier into the apparatus. The apparatus may also means to mix the solution in the reaction reservoir 20 to cause/expedite the reaction. The apparatus may further include a conduit, e.g. tubing, extending from the apparatus at outlet 24, to direct the gas formed, e.g. chlorine dioxide, to a collection vessel or holding tank.

The apparatus is useful in the generation of chlorine dioxide. In this regard, a gaseous carrier is received or pumped under pressure into the apparatus 10 via inlet 12, collects in chamber 14 and then feeds into the reaction reservoir 20 via conduit 16 to mix with a reactant solution of at least hypochlorite salt and trichloroisocyanuric acid. Mixing of the solution occurs as the compressed gas bubbles into the solution. Within about 3-10 minutes, chlorine dioxide is generated and released from the apparatus 10 through outlet 24 for collection.

The apparatus may be integrally formed or formed with separate, distinct parts that are made of suitable inert materials, e.g. that are resistant to corrosion on exposure to reactants used therein. For example, suitable materials for use in constructing the apparatus include inert metals such as stainless steel, as well as plastic materials.

Embodiments of the invention are described by reference to the following specific examples which are not to be construed as limiting.

### EXAMPLE 1

1. 0.7 g Sodium hypochlorite salt(up to 85% by weight)

2. 0.35 g Citric acid(up to 99% by weight)

3. 0.35 g Trichloroisocyanuric acid(up to 90% by weight)

4. 0.1 g Sodium bicarbonate(up to 99% by weight)

5. 50 ml Water

Reactants 1-4, as solids, were added to the water in a reaction vessel. Air was pumped into the water at a rate of 8 liter air per min for 5 minutes at room temperature. This generated up to 250 mg gaseous chlorine dioxide.

### EXAMPLE 2

2. 7 g Sodium hypochlorite salt(up to 85% by weight)

3. 3.5 g Citric acid(up to 99% by weight)

4. 3.5 g Trichloroisocyanuric acid(up to 90% by weight)

5. 1 g Sodium bicarbonate(up to 99% by weight)

6. 150 ml Water

Reactants 1-4, as solids, were added to the water in a reaction vessel. Air was pumped into the water at a rate of 8 liter air per min for 5 minutes at room temperature. This generated up to 2500 mg gaseous chlorine dioxide.

### EXAMPLE 3

The following comparison experiments were conducted:

A) 0.8 g sodium hypochlorite salt and 0.8 g citric acid were combined in a reaction vessel with water. Air was pumped in the vessel for 10 minutes. An amount of 14 mg of chlorine dioxide was generated.

B) 0.8 g sodium hypochlorite salt, 0.7 g trichloroisocyanuric acid and 0.2 g sodium were combined in a reaction vessel with water. Air was pumped in the vessel for 10 minutes. An amount of 196 mg of chlorine dioxide was generated.

C) 0.7 g sodium hypochlorite salt, 0.1 g sodium bicarbonate, 0.35 g trichloroisocyanic acid and 0.35 g citric acid were combined in a reaction vessel with water. Air was pumped in the vessel for 10 minutes. An amount of 250 mg of chlorine dioxide was generated.

We claim:

1. A method of producing chlorine dioxide comprising:
1) combining a hypochlorite salt and trichloroisocyanuric acid reactants in solid state in an aqueous reaction medium to form a solution; and
2) mixing the solution with a gaseous carrier under conditions suitable to generate chlorine dioxide.

2. A method as defined in claim 1, wherein the hypochlorite salt is an alkaline metal hypochlorite salt.

3. A method as defined in claim 2, wherein the hypochlorite salt is selected from the group consisting of sodium hypochlorite, lithium hypochlorite, potassium hypochlorite, rhuebidium hypochlorite, cesium hypochlorite and francium hypochlorite.

4. A method as defined in claim 3, wherein the hypochlorite salt is sodium hypochlorite.

5. A method as defined in claim 1, wherein the hypochlorite salt is present in the mixture in an amount ranging from about 40-60% by weight of the dry reactants.

6. A method as defined in claim 1, wherein the trichloroisocyanuric acid is present in the mixture in an amount ranging from about 20-30% by weight of the dry reactants.

7. A method as defined in claim 1, wherein an organic acid in solid state is combined with the reactants.

8. A method as defined in claim 7, wherein the organic acid is selected from the group consisting of citric acid, lactic acid, formic acid, acetic acid and oxalic acid.

9. A method as defined in claim 8, wherein the acid is citric acid.

10. A method as defined in claim 7, wherein the organic acid is present in the mixture in an amount ranging from about 20-30% by weight of the dry reactants.

11. A method as defined in claim 1, wherein a bicarbonate in solid state is combined with the reactants.

12. A method as defined in claim 11, wherein the bicarbonate is sodium bicarbonate.

13. A method as defined in claim 11, wherein the bicarbonate is present in an amount ranging from about 5-10% by weight of the dry reactants.

14. A method as defined in claim 7, wherein the organic acid and the trichloroisocyanic acid are present in the mixture in about equal amounts.

15. A method as defined in claim 7, wherein the hypochlorite salt is present in the mixture in an amount that is about double the amount of the organic acid and trichloroisocyanic acid.

16. A method as defined in claim 1, wherein the gaseous carrier is air.

17. An apparatus comprising:
an inlet adapted to receive a compressed gaseous carrier, said inlet being in communication with at least one conduit that extends into a reaction reservoir, wherein the conduit has an opening such that the gaseous carrier is fed into a solution within the reservoir, and
at least one outlet adapted to release gas from the reaction reservoir, wherein the inlet is partitioned from the outlet to prevent admixture of the incoming gaseous carrier with the gases being released from the reservoir via the outlet.
